(19) United States
(12) Patent Application Publication
(10) Pub. No.: US 2018/0341529 A1
(43) Pub. Date: Nov. 29, 2018

(54) HYPERVISOR-BASED SECURE CONTAINER

(71) Applicant: Microsoft Technology Licensing, LLC, Redmond, WA (US)

(72) Inventors: Lei Kou, Redmond, WA (US); Pushkar V. Chitnis, Bellevue, WA (US); Simon Leet, Redmond, WA (US)

(73) Assignee: Microsoft Technology Licensing, LLC, Redmond, WA (US)

(21) Appl. No.: 15/606,376

(22) Filed: May 26, 2017

(51) Int. Cl. G06F 9/50; G06F 9/455

(52) U.S. Cl. CPC G06F 9/5077; G06F 21/575; G06F 9/45558

(57) ABSTRACT

A “Hypervisor Secure Container” (HSC) is a block of memory space that resides inside of a regular process, but is secured from the operating system of the computer it runs on. The HSC is a software container that runs on a hypervisor directly. Data and code within one HSC can only be accessed by the hypervisor itself and the code that belongs to the same HSC. The HSC can run in user mode or kernel mode. Advantageously, even if the operating system or user of the computer the HSC runs on is malicious, the data inside the HSC is still secure. The HSC allows software based isolation of code/data and can be used in various security contexts including securely storing certificates and passwords, performing Digital Rights Management (DRM) for media and games, and confidential computing in a computing cloud.

### BACKGROUND

A Trusted Computing Base (TCB) is typically defined as the portion of a system that is relied on to enforce the security policy of a computing platform. In order to prove that a TCB has been properly established on a platform, and to ensure that access to sealed data is only allowed on proper establishment of the TCB, various measurement parameters can be defined. Over time, modern TCBs have become complex, thus making it increasingly difficult to prove or otherwise verify that a TCB is properly and securely established for a particular computing platform. Evaluation of the security and integrity of the platform state is also difficult when the trustworthiness of the operating system and/or users of the computing platform cannot be established.

Many computing systems use virtual machines. In general, a virtual machine (VM) is a software implementation of a machine (e.g., a computer) that executes programs like a physical machine. In a virtualization environment, the operating system (OS) runs above a hypervisor. A hypervisor or virtual machine monitor (VMM) is computer software, firmware, or hardware that creates and runs virtual machines. A computer on which a hypervisor runs one or more virtual machines is called a host machine, and each virtual machine is called a guest machine. Applications and drivers that run on the OS depend on the OS only and most of them do not even know that the hypervisor exists. Typically, these applications and drivers have to trust the OS and treat the OS as part of the TCB. Once a user has administration privileges for the OS, he or she has the ability to read and write to all memory of the applications and drivers. The user can be a legitimate user, or can be a hacker, once they control the OS; there is typically nothing to prevent them from reading or writing to any sensitive data resident on the computer.

A traditional way to provide security for a computer is to avoid allowing the OS to be hacked. For example, anti-virus software can be installed, software upgrades fixing security vulnerabilities can be released, and various computer policies can be enforced. These techniques provide mitigation, but do not really solve security problems. Even a huge TCB cannot protect sensitive data stored on a computer from a malicious administrator, and cannot protect the sensitive data from the OS itself.

Some computing environments provide security using virtual machines (VMs) in these environments. A guest virtual machine (VM) includes an independent instance of an operating system (called a guest operating system) and its associated software and information. The host machine, hypervisor, host OS and guest OS make up the overall virtualization environment. A virtual machine monitor (VMM) or hypervisor intermediates between the hardware and the guest VM. It presents the guest VM a set of virtual computing resources—such as processing power, memory, disk and network I/O (input/output), and so on. By isolating individual guest VMs from each other, the VMM enables a host to support multiple guests running different operating systems. The user data and applications are isolated into separate VMs. This reduces the attack surface somewhat.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of prior technologies may be noted or discussed herein, the claimed subject matter is not intended to be limited to implementations that may solve or address any or all of the disadvantages of those prior technologies.

In general, a “Hypervisor-based Secure Container,” as described herein, is a block of memory space that is associated with a regular process, but that is secured from the operating system of the computer it runs on. A hypervisor-based secure container (HSC) is a software container that is controlled by a hypervisor directly. Data and code within one HSC can only be accessed by the hypervisor itself and other code that belongs to the same HSC. The HSC can run in user mode or kernel mode. Advantageously, even if the operating system is malicious, the data inside the HSC is still secure. The HSC allows software-based isolation of code/data and can be used in various security contexts including, for example, securely storing certificates and passwords, performing Digital Rights Management (DRM) for media and games, and for confidential computing in a computing cloud (for example, executing code in a cloud without trusting a given VM or Host administrator and kernel).

In general, one exemplary process for creating a HSC can be summarized as follows. A hypervisor of a computing device starts up and sets up an HSC manager inside it. The HSC manager is responsible for implementing HSC related hyper-calls inside the hypervisor. For example, the HSC manager provides hypercalls to create, destroy, call in to or leave a HSC. The hypervisor also sets up a hypercall page to support HSC management routines (e.g., calls between a guest operating system and the hypervisor or calls between the host operating system and the hypervisor). As the operating system (OS) starts up on the hypervisor, the hypervisor maps the hypercall page to a guest physical address. A regular process (e.g., a process initiated by any application on the OS) starts up on that OS. The process issues a hypercall to the HSC manager via the hypervisor to create a HSC which will call to the hypervisor. When the hypervisor receives the call to create a HSC, the hypervisor (via the HSC manager) creates a HSC for that process and returns a handle of the HSC to the process. The process then issues a hypercall to load data into the HSC and initializes the HSC. After initialization is completed, the data stored in the HSC can only be accessed by the hypervisor and (other code within) the HSC itself. The process uses hypercalls to call interfaces defined by the HSC to complete secure computing.

When the hypervisor creates a HSC, the hypervisor also creates/maintains a map of which pages in memory are HSC pages and which pages are not HSC pages. Every time there is a request for access to a page of memory within the HSC, the hypervisor checks which entity is asking for it. If the calling entity is in HSC mode, and the page of memory belongs to it that request is allowed to access the HSC page. If the code is executing outside of the HSC (normal mode) the process/requester is not allowed to access the HSC.

Once the HSC is created and initialized, secure processing via the HSC can take place. Two possible ways to protect the HSC memory via the hypervisor so that the data of a HSC cannot be accessed by the regular OS kernel or any user involve using Second Level Address Translation (SLAT) and/or by using a Translation Lookaside Buffer (TLB) missing handler process.

In view of the above summary, it is clear that the HSC implementations described herein establish and maintain the security of data in an arbitrary computing platform or distributed computing platforms and results in a small TCB. In addition to the just described benefits, other advantages of the HSC implementations will become apparent from the detailed description that follows hereinafter when taken in conjunction with the accompanying drawing figures.

### BRIEF DESCRIPTION OF THE DRAWINGS

The specific features, aspects, and advantages of the claimed subject matter will become better understood with regard to the following description, appended claims, and accompanying drawings where:

FIG. 1 provides an exemplary virtualization overview that depicts both a traditional architecture and a virtual architecture.

FIG. 2 provides an exemplary system diagram that illustrates program modules for implementing various embodiments of the Hypervisor-based Secure Container (HSC), as described herein.

FIG. 3 provides a general flowchart of an exemplary process for creating a HSC.

FIG. 4 provides a more detailed flowchart of an exemplary process for creating a HSC when one or more HSCs are used with Virtual Machines and guest operating systems.

FIG. 5 provides a more detailed flowchart of an exemplary process for creating a HSC when one or more HSCs are used with a computing device's operating systems (e.g., a host operating system).

FIG. 6 illustrates an exemplary process for using and protecting the HSC memory using the hypervisor, so that the data of a HSC in memory cannot be accessed by a regular OS kernel. This exemplary process uses a Second Level Address Translation (SLAT), as described herein.

FIG. 7 illustrates an exemplary process for protecting the HSC memory in the hypervisor, so that the data of a HSC in memory cannot be accessed by a regular OS kernel. This exemplary process uses a Translation Lookaside Buffer (TLB) missing handler process, as described herein.

FIG. 8 is a general system diagram depicting a simplified general-purpose computing device having simplified computing and I/O capabilities for use in implementing various embodiments of the Hypervisor-based Secure Container, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Hypervisor-Based Secure Container Implementations:

In the following sections an overview of a virtualization architecture and an overview for creating and using Hypervisor-based Secure Containers (HSCs) will be provided. Additionally, an exemplary system architecture and exemplary processes for creating and using HSCs, and exemplary scenarios for use of such HSCs, are also discussed.

1.1 Virtualization Architecture Overview

A virtualization architecture is a conceptual model specifying the arrangement and interrelationships of the particular components involved in delivering a virtual—rather than physical—version of something, such as an operating system (OS), a server, a storage device or network resources.

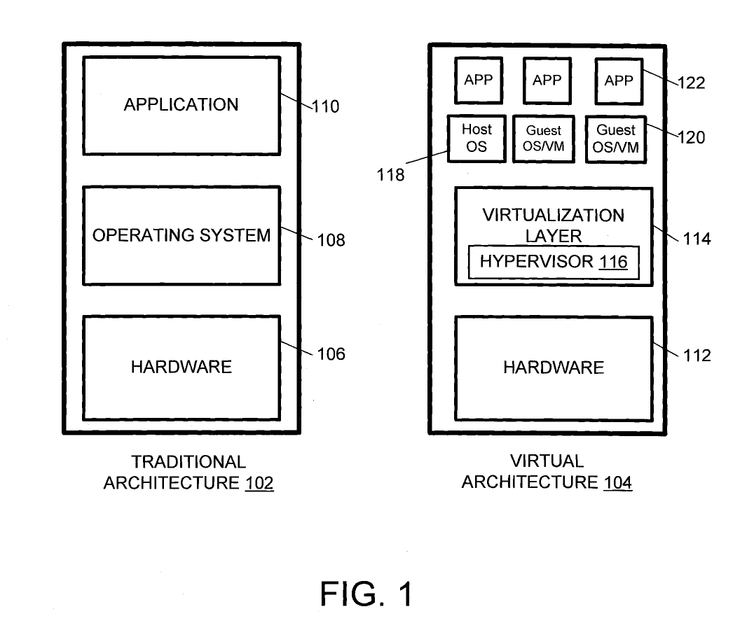

FIG. 1 depicts the difference between a traditional computing architecture 102 and a virtualization architecture 104. As can be seen in FIG. 1, the traditional architecture 102 includes a hardware layer 106, an operating system layer 108 and an application layer 110. In contrast, while the virtualization architecture 104 also includes a hardware layer 112, it includes a virtualization layer 114. The virtualization layer 114 is where the hypervisor 116 of a computing device resides. The virtualization architecture 104 can also include multiple operating systems, to include a host OS 118 and one or more guest operating systems 120, one for each virtual machine (VM) created by the hypervisor. Each OS in the virtualization architecture can interface with its own applications 122, where the applications from one OS are isolated from the applications that run on a different OS.

The hypervisor isolates operating systems and applications from the underlying computer hardware so the host machine can run multiple virtual machines (VMs) as guests that share the system's physical computer resources, such as processor cycles, memory space, network bandwidth and so on. There can also be different types of hypervisors.

Type 1 hypervisors, sometimes called bare-metal hypervisors, run directly on top of the host system hardware. Bare-metal hypervisors offer high availability and resource management. Their direct access to system hardware enables better performance, scalability and stability.

A type 2 hypervisor, also known as a hosted hypervisor, is installed on top of the host operating system, rather than sitting directly on top of the hardware as the type 1 hypervisor does. Each guest OS or VM runs above the hypervisor. The convenience of a known host OS can ease system configuration and management tasks. However, the addition of a host OS layer can potentially limit performance and expose possible OS security flaws.

1.2 Hypervisor-Based Secure Container (HSC) Overview.

In general, the “Hypervisor-based Secure Container” (HSC) implementations, as described herein, securely store data in memory associated with a regular process by creating a HSC. The HSC depends just on the hypervisor itself (and the hypervisor privilege ring enforced by the CPU) to provide data protection against kernel privileged actors, for applications running on top of that kernel.

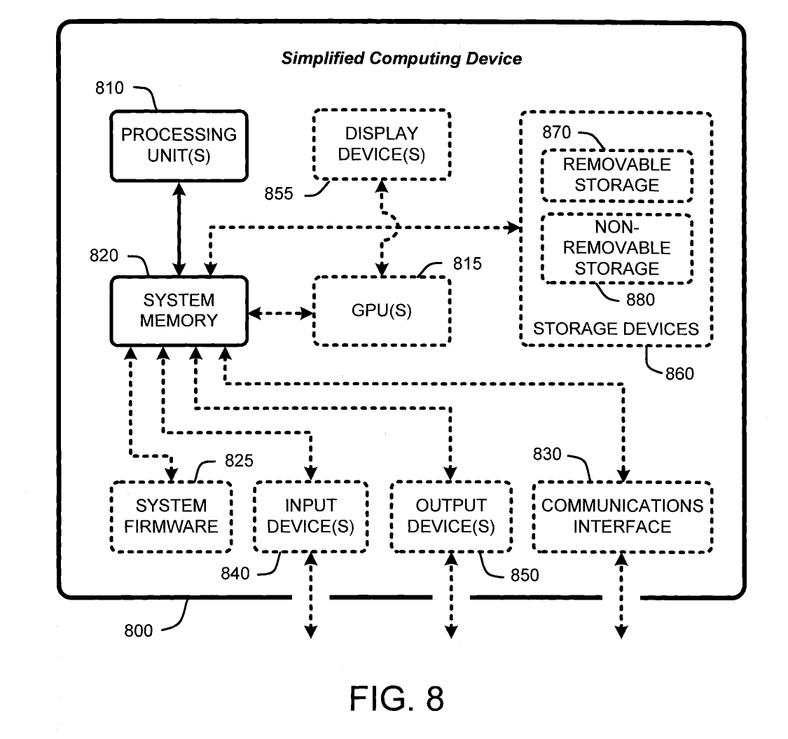

To understand the HSC implementations described herein, a general overview of the components of a computing device, like the computing device 800 described in more detail with respect to FIG. 8, is useful. To this end, it is well known that all code runs on a computer processing unit (CPU). On a hardware level there is a processor unit that runs code and there is a large amount of memory that is undifferentiated. In order for a program to run it must be loaded some way in memory so that the CPU can find the memory (e.g., in Random Access Memory (RAM)), load it and execute it. The operating system (OS) manages this process for different programs. To do so, the operating system stipulates address ranges in memory that are owned by different processes. For example, the OS stipulates that a certain address range in memory is owned by process A, and process B has a different address range. In a typical computing system, the OS maintains all of this information. This stops process A and process B from attacking each other (one process cannot look at the memory of another). However, in the HSC implements described herein, the assumption is made that it is undesirable for the operating system to know every program's memory. So the HSC implementations described herein employ a hypervisor (that is typically responsible for partitioning memory space between virtual machines) to create and use HSCs. Like the OS that partitions memory space for different processes, the hypervisor splits its own memory space into different virtual machines and the operating system only sees this chunk of memory that is allocated for that virtual memory. The hypervisor can be thought of as a lower level controller and therefore it can prevent the OS from seeing pages that are part of a given virtual machine. Instead of allowing the OS to partition the memory directly, the HSC implementations described herein create one or more HSCs that require the OS to go to the hypervisor to ask for access to memory pages. The hypervisor has control of whether the operating system sees a requested page or not. For example, when a process executes, it tells the operating system that it is running in HSC mode and the operating system must go to hypervisor to request access to a certain page or address in memory. In response, the hypervisor tells the process whether it can access a certain page or not.

The HSC manager of the hypervisor is a new extension to the hypervisor. Within the VM space this HSC manager is a special partition in itself. The HSC manager is responsible for allocating and tracking pages for the HSC itself. Within a VM there is an address range there can be many HSCs and the HSC manager tracks which HSC owns which particular pages in memory.

HSC embodiments as described herein have the following advantages compared to previous solutions for protecting sensitive data and code on a computing device:

The HSC results in a very small TCB. The TCB of a HSC implementation includes firmware in the computer, the hypervisor and the HSC. The Host OS is not included in the TCB.

The HSC memory cannot be accessed from outside of its TCB. Even if a malicious user controls the OS kernel, the data in a HSC is still isolated since it is protected by the hypervisor.

The size of HSC is only limited by physical memory size and process address space.

One HSC can be mapped to one or more processes. Once a HSC is created and initialized, the hypervisor can provide access to this HSC to other processes. The HSC is an entity managed by the hypervisor. The hypervisor can choose to expose the HSC to different processes.

Because all APIs are exposed by the hypervisor, the HSC can be exposed to VMs transparently. This makes HSC implementations as described herein very attractive in a cloud environment. Because, in some implementations, all APIs are exposed through hypercall pages, both the host OS and the guest OS talk to the HSC through these hypercalls.

The HSCs as described herein are part of the same process space (memory area) of an untrusted process. HSCs use the same process memory but are isolated from that process using the hypervisor as TCB. This provides protection from the kernel.

1.3 System Overview:

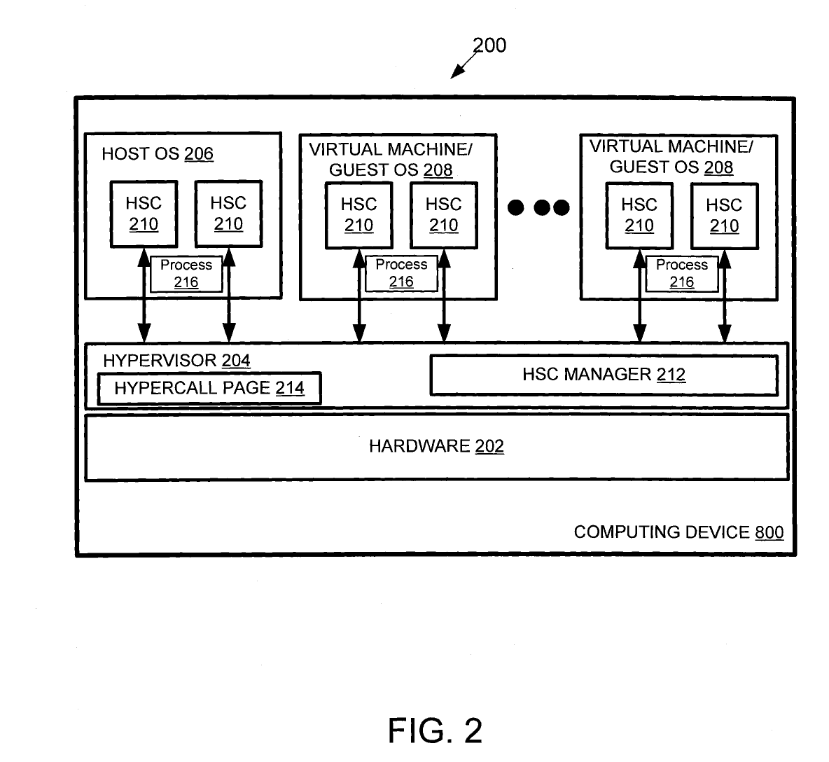

The system diagram of FIG. 2 illustrates the interrelationships between program modules for various Hypervisor-based Secure Container (HSC) implementations, as described herein. Furthermore, while the system diagram of FIG. 2 illustrates a high-level view of various embodiments of HSC implementations, FIG. 2 is not intended to provide an exhaustive or complete illustration of every possible HSC embodiment.

In addition, it should be noted that any boxes and interconnections between boxes that may be represented by broken or dashed lines in FIG. 2 represent alternate embodiments of the HSC implementations described herein, and that any or all of these alternate embodiments, as described below, may be used in combination with other alternate embodiments that are described throughout this document.

In general, HSCs can be used to perform any secure computation in a consumer environment, cloud environment and enterprise environment. The security of using and creating passwords and certificates which the kernel cannot access, DRM for media and/or games, and confidential computing in a computing cloud are all possible usage scenarios for HSC. HSCs can execute code in a public cloud environment while not corrupting the OS in the cloud when the administrator of VM is untrusted. Creation and usage of HSCs can be applied to any application that requires data to be secured from the OS and administrator. HSCs can be used for secure computing on a machine (even if machine hacked) and in a public cloud (in the case of an untrusted administrator of the cloud), because even the administrator of the cloud cannot access data in a HSC.

Even though a hypervisor runs on single machine and isolates HSCs on a single machine, HSCs can be used in a distributed environment because in a distributed environment each single computing device will typically have a hypervisor.

In some implementations, to create a HSC, any regular process (any program) can request the hypervisor through a hypercall to create an HSC and a HSC will be created through the hypervisor in the requesting process's memory space. For example, the process has a memory footprint. When the process is running it can request the hypervisor through a hypercall to create the HSC and the hypervisor in the same virtual address space of the process will create a special memory block that is isolated from the process itself and from the OS, and that can be used for secure computation, but no new process is created. If one tries to observe this memory one will see a non-readable memory block. Data in the HSC is invisible to the operating system. It looks encrypted even though it is still running. The HSC contains not only the information to be acted on but also the code that will act on it. The operating system cannot see this data but the hypervisor and the code inside the HSC can see the data/information. Data and code inside the HSC can only be accessed by the hypervisor so the HSC can be used to protect, for example, medical data, financial data, certificates and passwords and other confidential or sensitive data.

Once a HSC is created and initialized it can send data. It does this by providing its identities and properties. The hypervisor can verify the HSC's identities and properties and can verify the HSC is in a secure state and if so the data will be shared, if not (e.g., the administrator or operating system tampered with it) data in HSC will not be shared. So in the HSC implementations discussed herein, if the hypervisor is trusted then the OS and the administrator/user of the computing device can be untrusted because the HSC provides a secure container of code and data in an environment which may be untrusted.

FIG. 2 depicts an exemplary system 200 for various HSC implementations as discussed herein. More specifically, as illustrated by FIG. 2, the hardware 202 of a computing device 800 (which will be discussed in greater detail with respect to FIG. 8) sits below the hypervisor 204. Above the hypervisor 204, is the host OS 206 and one or more virtual machines (VM)/guest OSes 208. Both the host OS 206 and the one or more guest OSes 208 can use one or more HSCs 210 within their memory space.

To create a HSC to securely store data, the hypervisor 204 starts up and sets up the HSC manager 212 inside of it to manage the HSCs 210. The HSC manager 212 supports all of the hypercalls to manage the HSCs 210. It manages the calls to create and destroy HSCs and manages page relationships between first level address level and second level address translation pages and the HSCs. For example, when a process inside of an operating system wants to access data in an address (say move eax, [ebp] where ebp-0x00F3e840) that address is a process virtual address. The OS needs to translate that virtual address in to a physical address so that the hardware knows where to find the data related to the data access request. This translation happens inside the host OS or guest OS (in the case of a virtual machine). These operating systems will translate the virtual address to the guest physical address. That translation is called a first level address translation (which is typically called a Guest Virtual Address (gVA) to Guest Physical Address (gPA) translation). Second Level Address Translation (SLAT), also known as nested paging, is a hardware-assisted virtualization technology. It translates the guest physical address to a hardware physical address using a second level address translation table. This translation is controlled by the hypervisor (and is typically called a GPA to SPA translation).

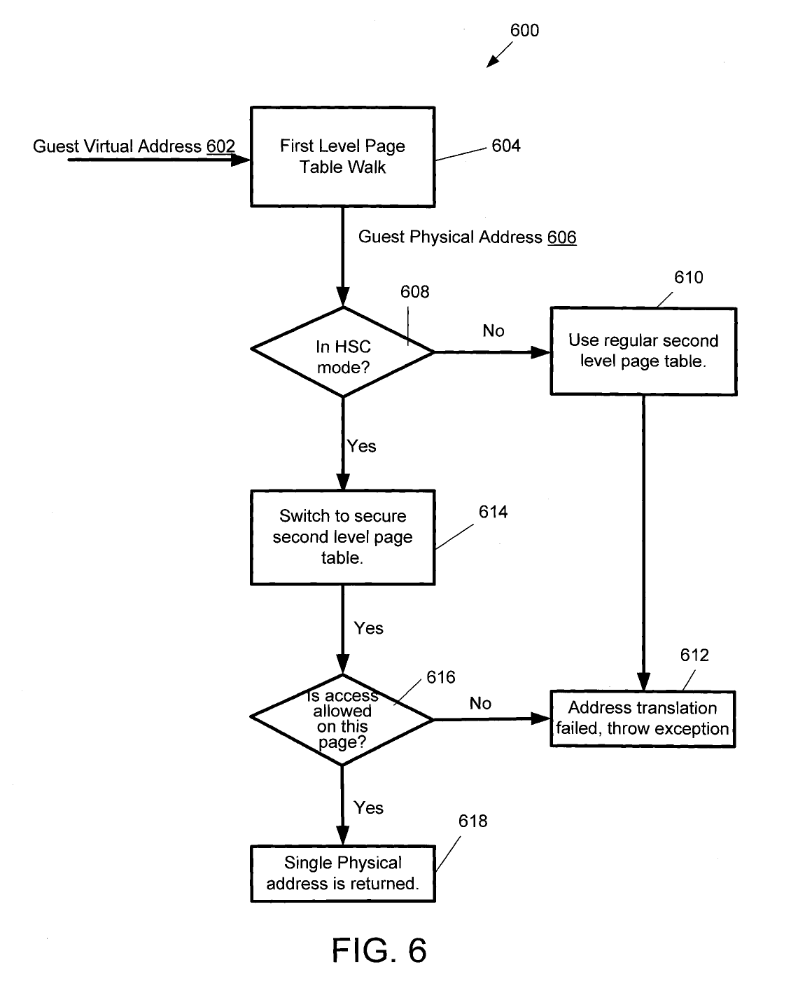

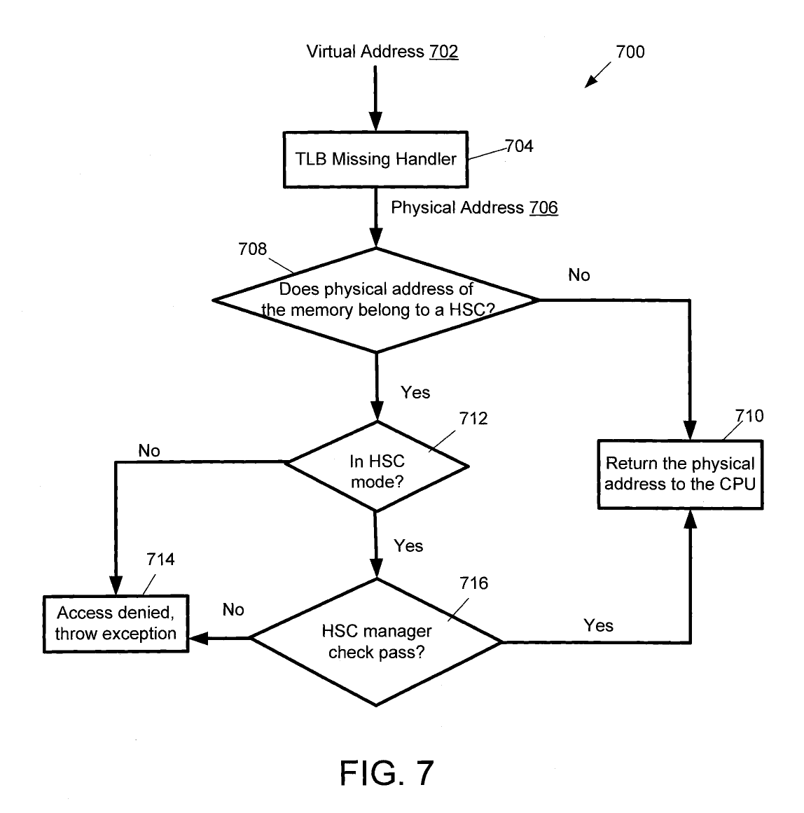

In order to create an HSC 210, the hypervisor 204 starts up and creates a HSC manager 212 inside of it, as well as a hypercall page 214. Then the OS (guest OS 208 or host OS 210) starts up. The hypercall page 214 is located in the hypervisor 204 but that hypercall page 214 is exposed to the guest OS 208. When the OS 206, 208 starts up the hypervisor needs to map this hypercall page 214 to a physical address space in computer memory 216 of the hardware 202 so that the hypercall page 214 is available to that guest OS 208. The hypercall page 214 is a mechanism of the hypervisor 204. An API interface is provided by the hypervisor 204, the API hypervisor page. The hypervisor 204 segments the computer memory 216 and provides implementations for VMs 208. The hypervisor 204 that creates this segment of VMs exposes the HSC management APIs to the VMs through hypercalls. Whenever the hypervisor exposes any API this can be thought of as a hypercall and the hypervisor can be called using hypercalls. Each VM needs to know which VM corresponds to physical memory, and uses the above discussed data pages to do this. The hypervisor uses the page tables to segment memory of a VM or to segment the physical memory of the host machine. A page table basically describes which page (in memory) belongs to the OS of a physical machine or the OS of a virtual machine. Once the hypervisor, HSCM and the hypercall page are set up, a regular process 216 starts up in the OS (either the host OS 206 or a guest OS 208). The regular process 216 can be any program inside the OS. The process 216 issues a hypercall (through the hypercall page 214) to the HSC manager 212 of the hypervisor 204 with a request to create a HSC 210. In response, the HSC manager 212 responds to this call and creates the HSC 210 and returns a handle to reach the HSC 210 to the process 216. The handle is an opaque handle for the HSC 210 (talk to it, shut it down, etc.). The process 216 issues a hypercall to load data into the HSC and to initialize the HSC 210. Executable code can also be loaded into the HSC 210. After initialization the HSC's 210 data and code can be only accessed by the hypervisor 204 and the code inside HSC itself. It is protected by the hypervisor 204. The process can use hypercalls to call interfaces defined by the HSC to complete secure computing. Examples of such secure computing are described in greater detail with respect to FIGS. 6 and 7.

An overview of an exemplary system for practicing HSC implementations as described herein having been provided the next section will discuss exemplary processes for creating and using HSCs.

1.4 Exemplary Processes:

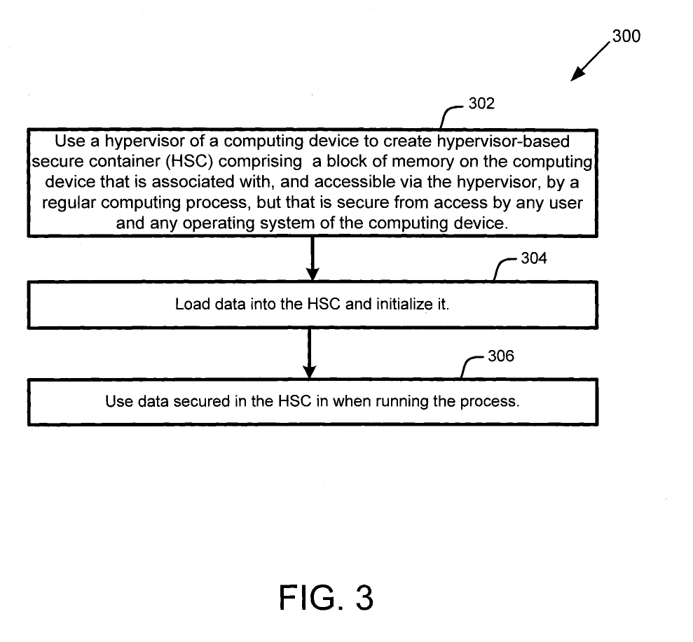

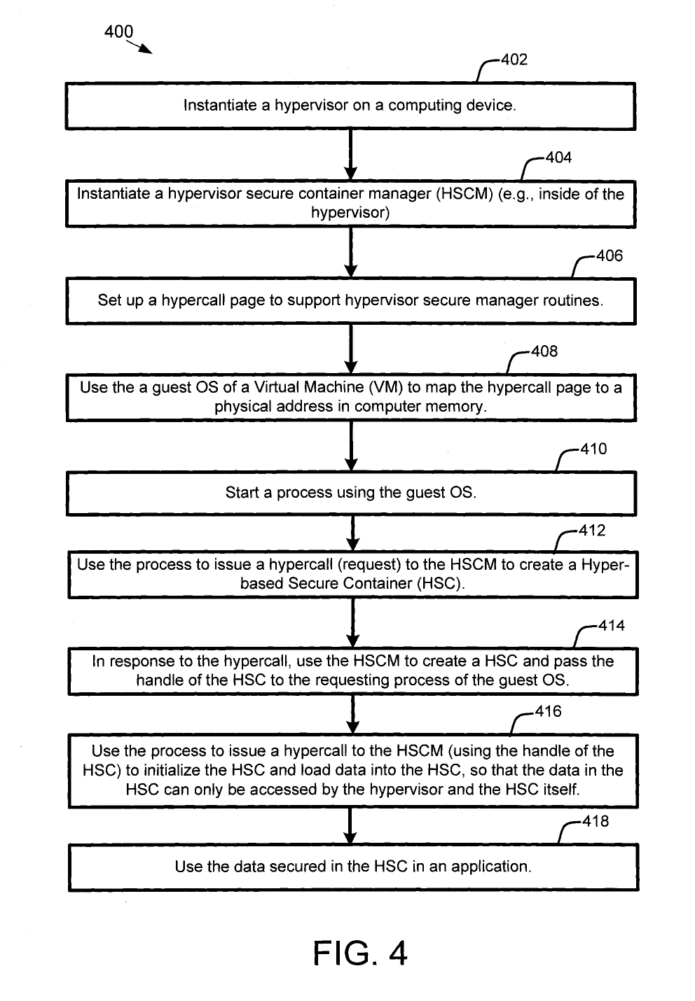

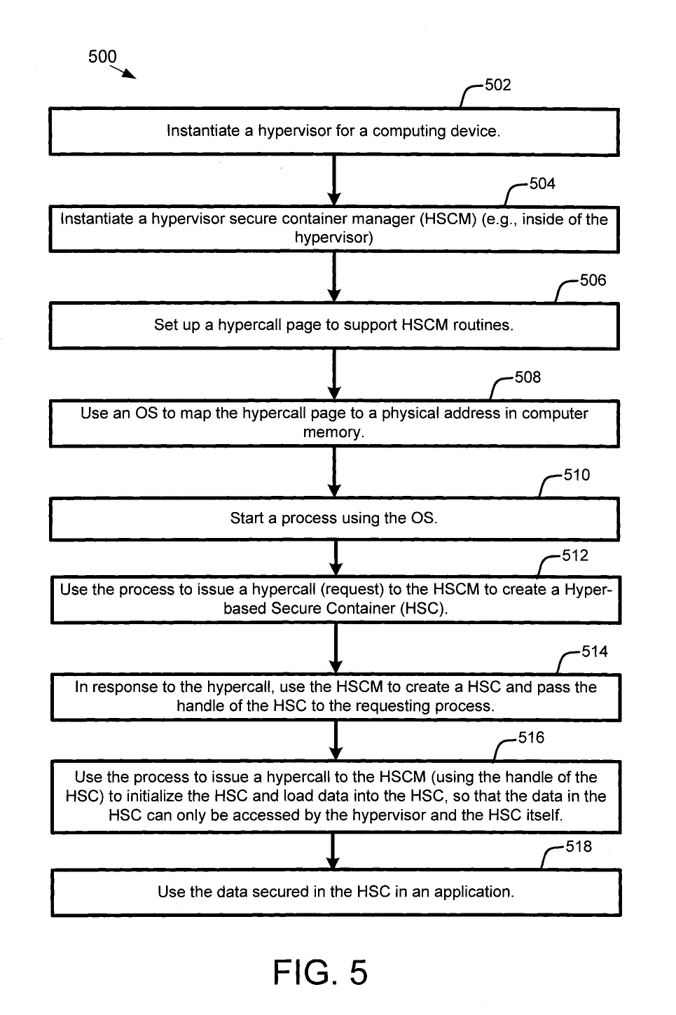

The following paragraphs and figures describe various processes for implementing HSCs. FIG. 3 depicts a high level exemplary process for creating and using a HSC. FIG. 4 depicts a more detailed exemplary process for creating and using a HSC when virtual machines are employed by the computing platform. FIG. 5 depicts a more detailed exemplary process for creating and using a HSC when no virtual machines are employed. FIG. 6 depicts one exemplary process for using a HSC once created and initialized. FIG. 7 depicts another exemplary process for using a HSC once created and initialized.

One exemplary process 300 for creating a HSC is shown in FIG. 3. As shown in block 302, a hypervisor of a computing device is used to create a hypervisor secure container (HSC). The HSC is a block of memory on the computing device that is associated with and accessible via a hypervisor by a regular computing process, but that is secure from access by any user and any operating system of the computing device. The HSC is loaded with data and the created HSC is initialized, as shown in block 304. The data can include code that is executable in the HSC. Once the data is secured in the HSC, the data (and any associated code in the HSC) can be used by the process/application that created the HSC (e.g. by calling functions exposed by the HSC), as shown in block 306. In some implementations, the HSC can be used by another process/application if the hypervisor allows it.

Another exemplary process 400 for creating a HSC in a virtualized environment is shown in FIG. 4. As shown in block 402, a hypervisor is instantiated on a computing device. A hypervisor secure container manager (HSCM) is also instantiated (e.g., within the hypervisor), as shown in block 404. A hypercall page is set up to support HSCM routines, as shown in block 406. A guest OS of a virtual machine is used to map the hypercall page to a physical address in computer memory, as shown in block 408. A regular process starts up in the (e.g., guest) OS, as shown in block 410. The regular process can be any process inside the guest OS. The process issues a hypercall (through the hypercall page) to the HSC manager of the hypervisor to create a HSC, as shown in block 412. In response, as shown in block 414, the HSC manager responds to this call and creates the HSC and returns a handle to reach the HSC to the process. As shown in block 416, the process issues a hypercall to load data to, and to initialize, the HSC. Executable code can also be loaded into the HSC. After initialization the HSC's data and code can be only accessed by the hypervisor and the code inside HSC itself. It is protected by the hypervisor. As shown in block 418, then the process can use hypercalls to call interfaces defined by the HSC to complete secure computing. Such secure computing using one or more HSCs, once loaded with data and initialized, are discussed with respect to FIGS. 6 and 7.

Another exemplary process 500 for creating a HSC is shown in FIG. 5. As shown in block 502, a hypervisor is instantiated on a computing device. A hypervisor secure container manager (HSCM) is also instantiated (e.g., within the hypervisor), as shown in block 504. A hypercall page is set up to support HSCM routines, as shown in block 506. The host OS of the computing device is used to map the hypercall page to a physical address in computer memory, as shown in block 508. As shown in block 510, a regular process starts up in the (e.g., host) OS. The regular process can be any program running on the OS. The process issues a hypercall (through the hypercall page) to the HSC manager of the hypervisor to create a HSC, as shown in block 512. In response, as shown in block 514, the HSC manager responds to this call and creates the HSC and returns a handle to reach the HSC to the process. The process issues a hypercall to initialize and load data to the HSC, as shown in block 516. Executable code can also be loaded into the HSC. After initialization the HSC's data and code can be only accessed by the hypervisor and the code inside HSC itself. It is protected by the hypervisor. As shown in block 518, the process can then use hypercalls to call interfaces defined by the HSC to complete secure computing. Such secure computing using one or more HSCs, once loaded with data and initialized, are discussed with respect to FIGS. 6 and 7.

FIG. 6 depicts a process 600 for using Second-Level Address Translation (SLAT) to securely process data using a created and initialized HSC. SLAT is a hardware virtualization technology that reduces hypervisor overhead. To do so, SLAT addresses the inefficiencies associated with looking up virtualized memory addresses in software shadow volumes. FIG. 6 depicts a process 600 that shows the protected use of data in a HSC by using a hypervisor and using SLAT. When a process on a guest OS wants to access data in a HSC, the guest process sends the virtual address for the pages in memory it wants to access. To this end, a guest virtual address 602 is received (e.g., by the guest OS kernel). A first level page table walk is performed (block 604) to output a guest physical address for the received guest virtual address of the HSC (block 606). A check is made to see if the computing system is operating in HSC mode (block 608). (To check if the requesting entity is in HSC mode, usually a HSC mode flag is set on the VM processor.) If the system is not operating in HSC mode, a regular second level page table is used to translate the received guest virtual address to the guest physical address (block 610), and it is determined that the address translation failed and an exception is thrown (block 612). (An exception is an event, which occurs during the execution of a program that disrupts the normal flow of the program's instructions. When an error occurs within a method, the method creates an object and hands it off to the runtime system.) If the system is operating in HSC mode, a switch is made to use a second level secure page table. The second level secure page table is used to determine if access is allowed on this page (block 616), if not it is determined that the address translation failed and an exception is thrown (612). If access is allowed, a single physical address is returned (block 618) which allows the process that created the request to access the data in this physical address (the address of the HSC).

FIG. 7 depicts an exemplary Translation Lookaside Buffer (TLB) missing handler process 700 for protecting the HSC memory in the hypervisor so that the data of one HSC cannot be accessed by the regular OS kernel. A TLB is a memory cache that is used to reduce the time taken to access a user memory location. It is a part of the chip's memory-management unit (MMU). The TLB stores the recent translations of virtual memory to physical memory and can be called an address-translation cache. A TLB may reside between the CPU and the CPU cache, between CPU cache and the main memory or between the different levels of the multi-level cache. The majority of desktop, laptop, and server processors include one or more TLBs in the memory management hardware, and it is nearly always present in any processor that utilizes paged or segmented virtual memory. As shown in FIG. 7, a virtual address 702 for an address a process wants to access is received. A TLB missing handler call is made (block 704) and a physical address corresponding to the virtual address is returned (block 706). A determination is made if the physical address belongs to an HSC or not (block 708) and if not the physical address is returned to the CPU (block 710). If the physical address belongs to the HSC a determination is made as to whether the system is in HSC mode (block 710). If not, access is denied and an exception is thrown (block 712). If the system is in HSC mode, a HSC manager check is made (block 716) The HSC manager will check 1) if the virtual processor is in HSC mode and 2) if the requested page belongs to the HSC. If either of these checks fail, the HSC manager will deny access. If the HSC manager check passes, the physical address is returned to the CPU (block 710). If the HSC manager check does not pass, access to the HSC is denied (and an exception is thrown) (block 714).

A system and processes for creating and using HSCs having been described, the following paragraphs describe exemplary scenarios which HSCs can be used.

1.5 Exemplary Scenarios for Using Hypervisor-Based Secure Containers:

HSCs allow software based isolation of code/data and can be used in various security contexts including securely storing certificates and passwords, performing DRM for media and games, confidential computing in a computing cloud (executing code in computing cloud without trusting any VM or Host administrator and kernel) and many other applications.

1.5.1 Secure Storage of Certificates and Passwords

Using the HSC implementations described herein certificates and passwords can be safely stored in a HSC and be protected from a malicious OS or a malicious administrator or user by using the hypervisor to manage access.

1.5.2 Performing DRM for Media and Games

HSCs are described herein can also be used for implementing digital rights management for media and games. For example, an Independent Software Vendor (ISV) can put account, license information and an anti-cheat engine inside of a HSC. Then when a game is launched, it must have a valid token from corresponding HSC. When the game is running, virtual money and the like is calculated inside the HSC, etc.

1.5.3 Confidential Computing in the Cloud

The HSC implementations described herein can provide confidential computing in a computing cloud. For example, consider the case of one or more servers of a bank and a user's computing device that seeks to interact with the bank's servers. The bank can give the user of the computing device an application so the user can access the bank's website on its server(s), but the bank also wants to guarantee that if the user's computing device is hacked, or has an OS exploit, the bank's server(s) will not be corrupted. When using HSCs the bank can ensure that its application and data can be secure within a HSC (for example, on the user's computing device). Hence, if execution of code in a remote location is desired, and the OS or hardware of the remote location is untrusted, it is still possible to perform trusted operations in the remote location. HSCs can securely communicate with remote entities (e.g., servers) by providing identifying information and properties of a particular HSC and other entities can verify the HSC's properties/identities to ensure that they belong to a particular trusted secure container. These properties can be identities that can be recognized as a signature and can be used to sign a HSC. For example, in the example above, the bank can check who signed the HSC and if the HSC is not signed by the bank, the bank will reject that HSC and not share any data with it. Identities and measurements (e.g., a HSC has a specific location in memory and has a hash which can be used as a measurement) can be verified to ensure secure computing with a HSC to determine whether the HSC has an expected specific measurement and identity. (For example, conventionally, the term “measurement” with respect to trusted computing refers to evaluating or measuring software binaries or other code such that the measurement result is both unique and indicates changes in the executable. As such, the resulting measurements can be compared to known information (e.g., a cryptographic hash value) to determine whether that software has been changed from a known or trusted state.)

1.5.4.1 Sealing of HSCs.

Before initialization, the HSC is said to be in a creation phase. The state at initialization can be captured by hypervisor as part of HSC's measurements (say a hash of all its pages) and can be used as a HSC's identity. After initialization, the HSC is free to update pages and or execute in HSC mode. For example, the hypervisor can mark certain code and data pages as HSCs. Executing code within the HSC pages or trying to access data in HSC pages in some implementations requires switching to HSC mode. The state at initialization can be captured by the hypervisor as part of the HSC's measurements (say a hash of all of its pages) and can be used as a HSC's identity, Only code in HSC mode or code in the hypervisor is allowed to access to pages reserved for the particular HSC.

To allow an HSC to persist encrypted secrets which can only be decrypted by HSC, the hypervisor binds the secrets with HSC properties such as identities, measurements, signers and other properties. This mechanism to store persistent secrets is called sealing. The measured identity established during initialization of a HSC can also be used as identity for sealing (the guarantee being that only another HSC which has the exact same measurements during initialization will be allowed to access the sealed secret in the future).

1.5.4.2 Signing of HSCs

To guarantee that HSC was produced by a particular entity, the HSC implementations described herein provide mechanisms for HSC developers to sign their binaries. This can be used for:

Code Integrity (CI) policy enforcement: The hypervisor can use a predefined policy to identify if HSC's by certain signers are allowed to be loaded and executed.

Identity management: A signing entity for a HSC contributes to its identity which can be used for:
a. Sealing: Storing persistent secrets which can only be decrypted by HSC with the same identity.
b. Remote attestation: Details are provided to a remote trusted entity that an HSC has come up and has a specific signer, identities and measurements. These should match what a remote trusted entity expects as attributes of their HSC.

2.0 Exemplary Operating Environments:

The Hypervisor-based Secure Container (HSC) implementations described herein are operational within numerous types of general purpose or special purpose computing system environments or configurations. FIG. 8 illustrates a simplified example of a general-purpose computer system on which various embodiments and elements of HSCs, as described herein, may be implemented. It should be noted that any boxes that are represented by broken or dashed lines in FIG. 8 represent alternate embodiments of the simplified computing device, and that any or all of these alternate embodiments, as described below, may be used in combination with other alternate embodiments that are described throughout this document.

For example, FIG. 8 shows a general system diagram showing a simplified illustration of a computing device 800. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a computing device 800 to implement the HSCs, the device should have a sufficient computational capability and system memory to enable basic computational operations. Further, the computing device 800 may also include optional system firmware 825 (or other firmware or processor accessible memory or storage) for use in implementing various embodiments of HSCs. In particular, as illustrated by FIG. 8, the computational capability is generally illustrated by one or more processing unit(s) 810, and may also include one or more GPUs 815, either or both in communication with system memory 820. Note that that the processing unit(s) 810 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 8 may also include other components, such as, for example, a communications interface 830. The simplified computing device of FIG. 8 may also include one or more conventional computer input devices 840 or combinations of such devices (e.g., pointing devices, keyboards, audio input devices, voice or speech-based input and control devices, video input devices, haptic input devices, touch input devices, devices for receiving wired or wireless data transmissions, etc.). The simplified computing device of FIG. 8 may also include other optional components, such as, for example, one or more conventional computer output devices 850 (e.g., display device(s) 855, audio output devices, video output devices, devices for transmitting wired or wireless data transmissions, etc.). Note that typical communications interfaces 830, input devices 840, output devices 850, and storage devices 860 for general-purpose computers are well known to those skilled in the art, and will not be described in detail herein.

The simplified computing device of FIG. 8 may also include a variety of computer readable media. Computer readable media can be any available media that can be accessed by computing device 800 via storage devices 860 and includes both volatile and nonvolatile media that is either removable 870 and/or non-removable 880, for storage of information such as computer-readable or computer-executable instructions, data structures, program modules, or other data. By way of example, and not limitation, computer readable media may comprise computer storage media and communication media. Computer storage media refers to tangible computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of HSC implementations described herein, or portions thereof, may be stored, received, transmitted, or read from any desired combination of computer or machine readable media or storage devices and communication media in the form of computer executable instructions or other data structures.

Finally, the HSC implementations described herein may be further described in the general context of computer-executable instructions, such as program modules, being executed by a computing device. Generally, program modules include routines, programs, objects, components, data structures. etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

The foregoing description of HSC implementations have been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of HSC implementations. It is intended that the scope of the invention be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented process for providing a secure computing environment, comprising:
using a hypervisor of a computing device to create a hypervisor-based secure container (HSC) comprising a block of memory of the computing device that is associated with and accessible via the hypervisor with a regular computing process, but that is secured from access by any user and any operating system the process runs on;
loading data into the HSC and initializing the HSC; and
calling functions exposed by the HSC to use the data secured in the HSC when running the process.

2. The computer-implemented process of claim 1, further comprising using a HSC manager on the hypervisor to assist in creating and managing the HSC.

3. The computer-implemented process of claim 1, wherein code inside of the HSC is run by exposing a set of functions to complete secure computing.

4. The computer-implemented process of claim 1 wherein the data secured in the HSC is securely used in a computing cloud.

5. The computer-implemented process of claim 1, wherein the HSC is signed.

6. The computer-implemented process of claim 1, wherein the HSC is sealed after initialization.

7. The computer-implemented process of claim 1, wherein the regular process is a banking application.

8. The computer-implemented process of claim 1, wherein Second-Level Address Translation (SLAT) is used to securely process the data secured in the HSC when running the regular process.

9. The computer-implemented process of claim 1, wherein a Translation Lookaside Buffer missing handler process is used to securely process the data secured in the HSC when running the regular process.

10. A computer-implemented process for providing a secure computing environment, comprising:
using a computing device for:
instantiating a hypervisor on a computing device;
instantiating a hypervisor secure container manager (HSCM) on the hypervisor;
setting up a hypercall page to support hypervisor secure container manager (HSCM) routines for creating and managing a Hypervisor-based Secure Container (HSC);
starting the operating system (OS) on the computing device;
using the operating system (OS) to map the hypercall page's virtual address to a physical address in the memory;
starting a process on the OS;
using the process to issue a hypercall (request) to the HSCM to create a HSC;
in response to the hypercall, using the HSCM to create a HSC and passing the handle of the HSC to the requesting process;
using the process to issue a hypercall to the HSCM (using the handle of the HSC) to load data into the HSC and to initialize the HSC, said data in the HSC can only being accessible by the hypervisor via a request by the process and the HSC itself.

11. The computer-implemented process of claim 10, further comprising using the initialized HSC by an application different from the regular process.

12. The computer-implemented process of claim 10, wherein the process uses hypercalls via the hypervisor to access the data stored in the HSC.

13. The computer-implemented process of claim 10, wherein the OS is host OS and wherein the process runs on the host OS.

14. The computer-implemented process of claim 10, wherein the OS is guest OS and wherein the process runs on the guest OS.

15. The computer-implemented process of claim 10, wherein multiple HSCs are created for the process using the hypervisor-based secure manager (HSCM).

16. The computer-implemented process of claim 10, wherein multiple HSCs are created, one or more for each process of multiple processes.

17. A system for securing data stored in computer memory, comprising:
a computing device having memory, the computing device comprising:
a hypervisor;
an operating system (OS);
one or more hypervisor-based secure containers, comprising blocks of memory that are associated with a process running on the operating system, that are created by the hypervisor in response to a request from the process, wherein the data and code within one HSC can only be accessed by the hypervisor in response to a request from the process and other code that belongs to the same HSC.

18. The system of claim 17 wherein the operating system is untrusted.

19. The system of claim 17 wherein the computing device is used by an untrusted user.

20. The system of claim 12 wherein the HSC can run in user mode or kernel mode securely.
